(19) United States
(12) Patent Application Publication
(10) Pub. No.: US 2007/0147911 A1
(43) Pub. Date: Jun. 28, 2007

(54) Image forming apparatus

(76) Inventor: Kiyohito Hirota, Chiba-shi (JP)

Correspondence Address: BRUCE L. ADAMS, ESQ., SUITE 1231, 17 BATTERY PLACE, NEW YORK, NY, 10004, US

(21) Appl. No.: 11/635,477

(22) Filed: Dec. 7, 2006

(30) Foreign Application Priority Data
Dec. 27, 2005 (JP) 2005-375103

(51) Int. Cl. G03G 15/20

(52) U.S. Cl. 399/322; 399/323

(57) ABSTRACT

Provided is an image forming apparatus for preventing a paper sheet such as a plain paper or a tracing paper from being waved immediately after fixation. Between a fixing roller (17) of a fixing roller pair in a fixing unit and a delivery roller (19) in a delivery unit, there is provided a unit for regulating a delivery direction of the paper sheet. The delivery direction of the paper sheet is once forcibly directed upward or downward with respect to a tangential direction of a nip portion of the fixing roller pair, thereby preventing waving of the paper sheet.

### BACKGROUND OF THE INVENTION

1. Field of the Invention

The present invention relates to an image forming apparatus employing an electrophotographic system. In particular, the present invention relates to a technique for preventing waving of a paper sheet caused by heat or pressure at a time of image fixation.

2. Description of the Related Art

There has been known a conventional image forming apparatus in which a rotatable cylindrical developer bearing member (hereinafter, referred to as developing sleeve) formed of a non-magnetic material is provided with magnetic field generating means which is fixed to an inside of the developer bearing member. Further, in the image forming apparatus, the developer (hereinafter, referred to as toner), which is carried toward a developing portion while being retained on the developing sleeve by a magnetic force caused by the magnetic field generating means, is regulated to have a predetermined film thickness by a contact pressure due to a developing blade, and is then moved to a cylindrical latent image bearing member (hereinafter, referred to as photosensitive drum) in the developing portion, thereby developing a latent image formed on the photosensitive drum.

In such the image forming apparatus, a recording medium to which an image is transferred from the photosensitive drum is conveyed to a fixing portion and receives heat and a pressure, thus the image is fixed thereto.

In the following, with reference to FIG. 4, a description will be made of the fixing portion of the conventional image forming apparatus. In FIG. 4, a fixing roller 17 is formed of metal such as aluminum or iron, and coating is effected on an outer surface thereof such that toner does not adheres thereto, and Okitsumo treatment by a product of Okitsumo Inc. is effected on an inner surface thereof for enhancing a heat efficiency thereof. The fixing roller 17 includes therein a halogen lamp 21. The halogen lamp 21 lights up, thereby heating the fixing roller 17. Regarding the fixing roller 17 whose surface temperature is detected by a thermister 22, through a control substrate (not shown), feedback on the surface temperature is made to an on/off control of the halogen lamp 21 in order to maintain a proper surface temperature. A support roller 18 has a surface layer formed of spongy soft rubber, includes therein a metal cored bar, and abuts on the fixing roller 17 so that a proper pressure thereof with respect to the fixing roller 17 is maintained. A separation claw 23 serves for removing from the fixing roller 17 a paper sheet wrapped therearound. The paper sheet delivered by the fixing roller 17 passes through a delivery guide 24 and is then discharged to an outside of the image forming apparatus by a discharge roller 19 and a driven roller 20. A rotational speed of the discharge roller 19 is higher by several percent than that of the fixing roller 17, thereby pulling the paper sheet therebetween. Further, in order to disperse stress, which is applied to the paper sheet by pulling the paper sheet, a nip pressure of the driven roller 20 with respect to the discharge roller 19 varies depending on a position in a width direction. That is, the nip pressure is higher at a center and is lower at both ends in the width direction.

In such the image forming apparatus, cockling or waving is caused in a longitudinal direction of the recording medium after image fixation. In particular, the cockling is caused in a case where an image is fixed to a thin paper sheet such as tracing paper. A cause of such the cockling may be considered to be because there are differences in heat distribution, pressure distribution, and a way of being cooled of the fixing roller at the time of discharge with respect to the recording medium in the width direction and the stress applied to the recording medium differs in the width direction.

In order to prevent the cockling or waving, a countermeasure is taken such that a speed difference is provided between the fixing roller and the discharge roller to allow the paper sheet to sag a little or to be taut a little therebetween, or that the nip pressure of the discharge roller is changed depending on a position.

Further, as in the document of JP2004-77621A, there is proposed a technique for preventing the recording medium from being bent by provision of cooling means between the fixing roller and the discharge roller.

However, with a method in which the speed difference between the fixing roller and the discharge roller is varied, when a width of the paper sheet increases or a type of the paper sheet changes, the cockling or waving is caused again. Therefore, it is difficult to completely deal with various media to be recorded.

Further, with a method in which the cooling means is provided between the fixing roller and the discharge roller, an additional member or a control circuit for cooling is further provided to the image forming apparatus, thereby making it difficult to downsize the image forming apparatus and to decrease manufacturing costs thereof.

### SUMMARY OF THE INVENTION

The present invention has been made to solve the problems of the conventional structure, and it is therefore an object of the present invention to realize an image forming apparatus in which a paper path of a paper sheet is regulated by a simple structure, thereby preventing waving of the paper sheet which has undergone image fixation.

In order to achieve the above-mentioned object, the present invention provides an image forming apparatus, including: a sheet feeding device for feeding a paper sheet; image forming means for forming an image on the paper sheet; fixing means for fixing the image formed by the image forming means to the paper sheet; and discharge means for discharging the paper sheet to which the image is fixed by the fixing means from an image forming apparatus main body, characterized in that: the discharge means is provided with a delivery guide section directly behind the fixing means which is a fixing roller pair; and the delivery guide section is provided with delivery direction regulating means for regulating a delivery direction of the paper sheet to correct a direction of the paper sheet delivered from the fixing roller pair.

As described above, in the image forming apparatus according to the present invention, it is possible to prevent, by applying a simple mechanism, waving of the paper sheet caused due to heat or a pressure at the time of image fixation.

### BRIEF DESCRIPTION OF THE DRAWINGS

In the accompanying drawings:

FIG. 1 is a schematic structural diagram of a fixing device according to a first embodiment of the present invention;

FIG. 2 is a schematic structural diagram of a fixing device according to a second embodiment of the present invention;

FIG. 3 is a schematic structural diagram of an image forming apparatus; and

FIG. 4 is a schematic structural diagram of a conventional image forming apparatus.

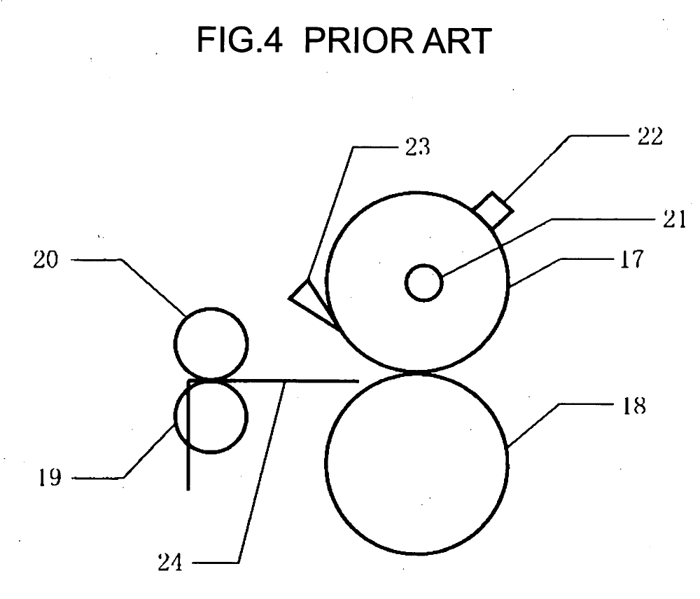

### DETAILED DESCRIPTION OF THE PREFERRED EMBODIMENTS

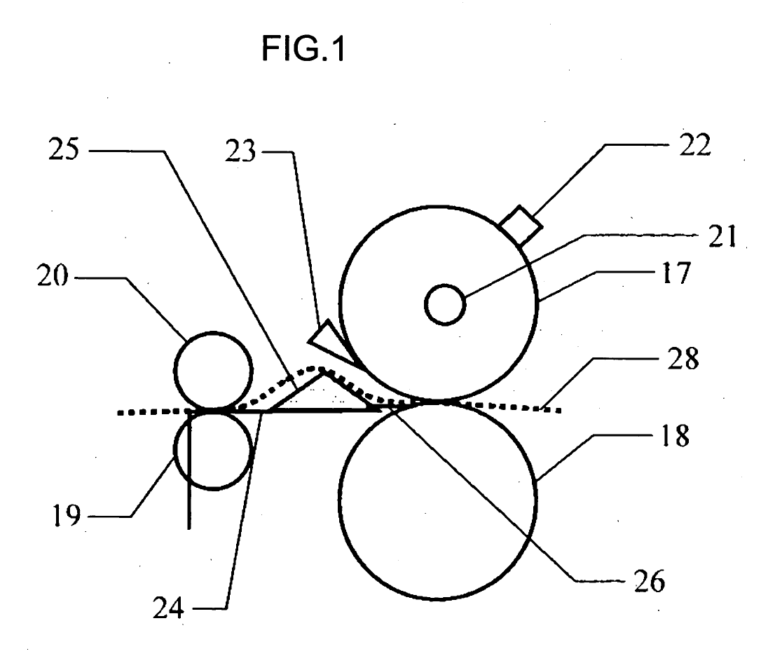

Hereinafter, embodiments of the present invention will be described with reference to FIGS. 1 to 3.

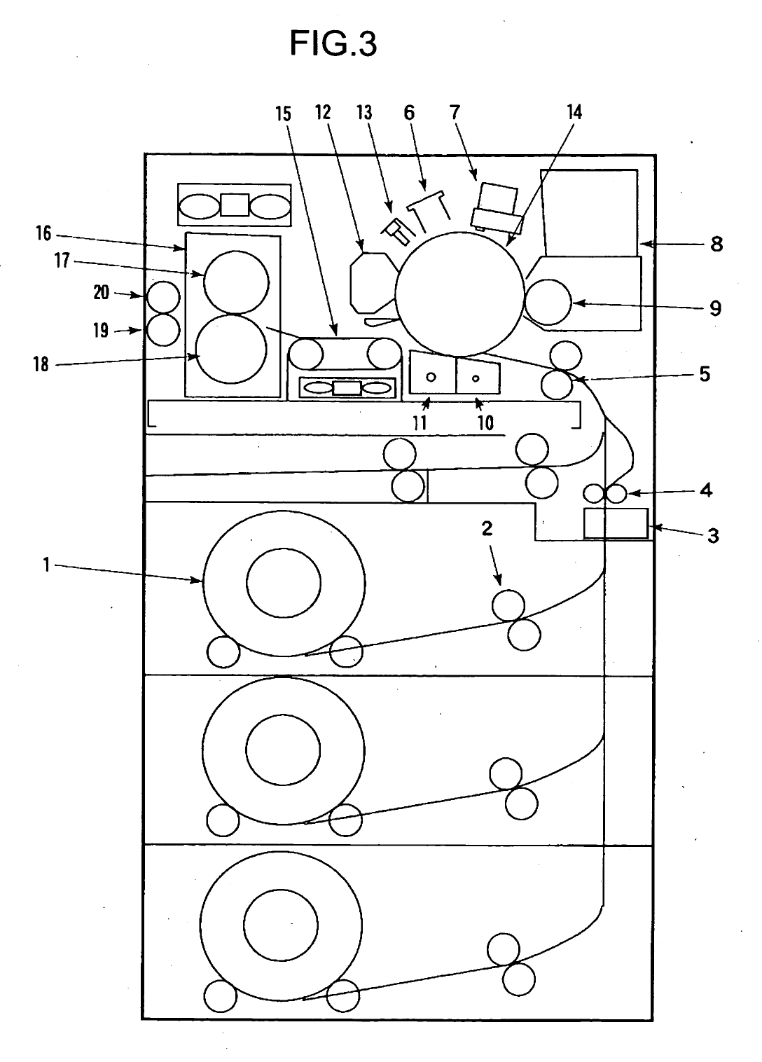

FIG. 3 is a sectional view schematically showing a device structure of an LED plotter serving as an image forming apparatus of an electrophotographic system, including a fixing portion (i. e., fixing means) according to an embodiment of the present invention.

A sheet feeding device is structured in a lower portion of the image forming apparatus. The sheet feeding device includes one to three sheet feeding portions each accommodating a roll paper 1. Each of the sheet feeding portions stores therein a paper sheet (i. e., recording medium). The paper sheets are different in width and/or kind among the sheet feeding portions. From the sheet feeding portion, the paper sheet is delivered by sheet feeding rollers 2. The paper sheet delivered passes through a portion of a paper cutter 3 and rollers 4 above the cutter. After that, a feed ratio of the paper sheet is pulse counted by a pulse motor (not shown) for driving registration rollers 5 at a position of the registration rollers 5. When counting of the paper sheet of a required length is completed, the paper cutter 3 cuts the roll paper 1.

In an image forming portion (i. e., image forming means) of the LED plotter, a static eliminator 13 refreshes a surface potential of a photosensitive drum 14 and a charger 6 charges the photosensitive drum 14. After that, data transmitted from a host such as a personal computer is rasterized by a RIP controller board (not shown), and an image is formed on a surface of the photosensitive drum 14 by an LED head 7 in a form of an inverted latent image. The latent image is developed by toner supplied from a developing sleeve 9 of a developing device 8, and a toner image of the inverted image is formed on the surface of the photosensitive drum 14.

A paper sheet delivered from the sheet feeding portion and arriving at the image forming portion sticks to the photosensitive drum 14 due to an electrostatic force, and receives on a back surface of the paper sheet a transferring bias from a transferring portion 10. As a result, the toner image on the photosensitive drum 14 is transferred to the paper sheet as a normal image. Then, the paper sheet receives a separating bias from a separating portion 11, to thereby be removed from the photosensitive drum 14.

Note that, on the surface of the photosensitive drum 14 after the toner image is transferred to the paper sheet, untransferred toner remains a little. Therefore, the untransferred toner is scraped off by a rubber cleaner blade (not shown), which is provided to a portion of a cleaner 12 so as to abut on the photosensitive drum 14 under an appropriate pressure, and the toner scraped off is stored in the cleaner 12.

The paper sheet on which the toner image is transferred from the photosensitive drum 14 passes through a conveyor device 15, which includes therein a fan for absorbing the paper sheet and serves for assisting conveyance of the paper sheet by rotation of a rubber belt, and is then delivered to the fixing portion.

The toner image transferred to the paper sheet receives heat and a pressure while passing between the fixing roller 17 and the support roller 18 (i. e., fixing roller pair) of a fixing device 16, thereby being fixed to the paper sheet. Then, the paper sheet is discharged to the outside of the image forming apparatus through the discharge roller 19 and the driven roller 20 constituting discharge means.

FIG. 1 is a sectional view showing a schematic structure of a fixing portion (i. e., fixing means) and the discharge means according to a first embodiment of the present invention. As shown in FIG. 1, a paper sheet delivered from a portion between the fixing roller 17 and the support roller 18 (i. e., nip portion) is once directed obliquely upward by a delivery direction regulating guide 25 (corresponding to delivery direction regulating means of the present invention) structured on a delivery guide 24. Note that, a paper sheet which attempts to travel below the delivery direction regulating guide 25 is scooped up by a winding prevention guide 26 attached to the delivery direction regulating guide 25 and coming into contact with the support roller 18, to thereby be guided to travel above the delivery direction regulating guide 25. The paper sheet once directed upward is again guided downward by an upper delivery guide (not shown), to thereby be discharged to the outside of the image forming apparatus through the discharge roller 19 and the driven roller 20.

The delivery direction regulating guide 25 has a convex shape, in other words, substantially constitutes a mountain-like shape which is gradually convexed from a base thereof when seen in a section as shown in FIG. 1.

An upper apex of the convex delivery direction regulating guide 25 is located so as to protrude upward (i. e., paper sheet regulating direction) from a plane including a tangential line of the nip portion between the fixing roller 17 and the support roller 18. With this structure, it is possible to effectively correct a direction of the paper sheet delivered by the fixing roller pair, thereby making it possible to eliminate cockling of the paper sheet.

Further, the base of the delivery direction regulating guide 25 overlaps with a circle having a radius of the smaller one of the fixing roller 17 and the support roller 18 and a center thereof corresponding to the nip portion between the fixing roller 17 and the support roller 18. With this structure, the paper sheet can be straightened by the delivery direction regulating guide 25 immediately after being delivered from the fixing portion.

Further, the delivery direction regulating guide 25 according to the present invention is provided along the axial direction of the fixing roller 17 and the support roller 18 across an entire length of the axis. The delivery direction regulating guide 25 may be provided as a single continuous member or the several delivery direction regulating guides 25 may be provided at appropriate intervals along the axial direction across the entire length of the axis.

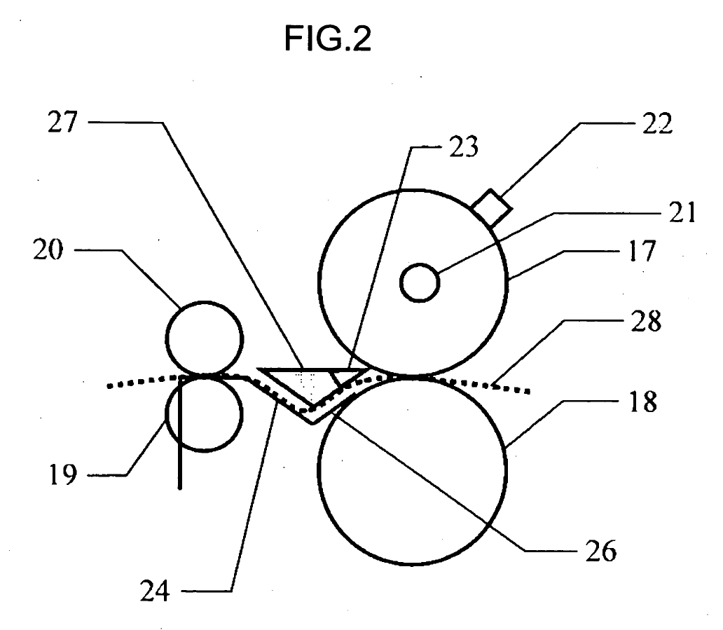

Next, FIG. 2 is a sectional view showing a schematic structure of a fixing portion (i. e., fixing means) and discharge means according to a second embodiment of the present invention.

As shown in FIG. 2, the paper sheet delivered from the nip portion between the fixing roller 17 and the support roller 18 is once directed obliquely downward by a delivery direction regulating guide 27 structured so as to be integrated with or separate from the separation claw 23 serving as paper sheet removing means. Note that, in order to prevent the paper sheet from being wound around the support roller 18, the delivery guide 24 is provided with a winding prevention guide 26 attached thereto and coming into contact with the support roller 18. The paper sheet directed downwards passes between an upper delivery guide (not shown) and the lower delivery guide 24 to be discharged to the outside of the image forming apparatus through the discharge roller 19 and the driven roller 20. In this embodiment, the nip portion between the discharge roller 19 and the driven roller 20 may be provided at the same height as the nip portion of the fixing roller 17 and the support roller 18 or below a plane including a tangential line of the nip portion of the fixing roller 17 and the support roller 18.

Further, the delivery direction regulating guide 27 has a downwardly convex shape, in other words, substantially constitutes an inverted mountain-like shape which is gradually convexed downwardly from an upper base thereof when seen in a section as shown in FIG. 2.

A lower apex of the delivery direction regulating guide 27 is located so as to protrude downward (i.e., paper sheet regulating direction) from the plane including the tangential line of the nip portion between the fixing roller 17 and the support roller 18. With this structure, it is possible to effectively correct the direction of the paper sheet delivered by the fixing roller pair, thereby making it possible to eliminate cockling of the paper sheet.

Further, the upper base of the delivery direction regulating guide 27 overlaps with a circle having a radius of the smaller one of the fixing roller 17 and the support roller 18 and a center thereof corresponding to the nip portion between the fixing roller 17 and the support roller 18. With this structure, the paper sheet can be straightened by the delivery direction regulating guide 27 immediately after being delivered from the fixing portion.

Further, the delivery direction regulating guide 27 according to the present invention is provided along the axial direction of the fixing roller 17 and the support roller 18 across the entire length of the axis. The delivery direction regulating guide 27 may be provided as a single continuous member or the several delivery direction regulating guides 27 may be provided at appropriate intervals along the axial direction across the entire length of the axis.

What is claimed is:

1. An image forming apparatus, comprising:
a sheet feeding device for feeding a paper sheet;
image forming means for forming an image on the paper sheet;
fixing means for fixing the image formed by the image forming means onto the paper sheet; and
discharge means for discharging the paper sheet onto which the image is fixed by the fixing means from an image forming apparatus main body, wherein:
the discharge means is provided with a delivery guide section directly behind the fixing means which is a fixing roller pair; and
the delivery guide section is provided with delivery direction regulating means for regulating a delivery direction of the paper sheet to correct a direction of the paper sheet delivered from the fixing roller pair.

2. An image forming apparatus according to claim 1, wherein the delivery direction regulating means performs regulation in one of an upward direction and a downward direction with respect to a tangential direction of a nip portion of the fixing roller pair.

3. An image forming apparatus according to claim 2, wherein the delivery direction regulating means starts regulation in a circle having a radius of one of rollers of the fixing roller pair, the circle having a center corresponding to the nip portion of the fixing roller pair.

4. An image forming apparatus according to claim 1, wherein the delivery direction regulating means is integrated with paper removing means coming into contact with the fixing roller pair.
An image forming apparatus according to claim 1, wherein the delivery direction regulating means starts regulation in a circle having a radius of one of rollers of the fixing roller pair, the circle having a center corresponding to the nip portion of the fixing roller pair.
